(19) United States
(12) Patent Application Publication
(10) Pub. No.: US 2025/0368868 A1
(43) Pub. Date: Dec. 4, 2025

(54) ADHESIVE COMPOSITION

(71) Applicant: DDP SPECIALTY ELECTRONIC MATERIALS US, LLC, Wilmington, DE (US)

(72) Inventors: Takiya FOSKEY, AUBURN HILLS, MI (US); Raymond BIS, AUBURN HILLS, MI (US); Gavin VOGEL, AUBURN HILLS, MI (US)

(21) Appl. No.: 18/877,775

(22) PCT Filed: Jun. 2, 2023
(86) PCT No.: PCT/US2023/024286

§ 371 Date: Dec. 20, 2024

Related U.S. Application Data
(60) Provisional application No. 63/394,398, filed on Aug. 2, 2022.

(51) Int. Cl. C09J 163/00; C09J 11/04; C09J 11/06

(52) U.S. Cl. CPC C09J 163/00; C09J 11/04; C09J 11/06

(57) ABSTRACT

Provided herein is an expandable epoxy adhesive.

### FIELD OF INVENTION

The present invention relates to the field of thermally-expandable adhesive compositions.

### BACKGROUND OF THE INVENTION

The current state-of-the-art in thermally expandable adhesives for automotive metal bonding relies on expandable thermoplastics, epoxy- and acrylic-based tapes and hot melt adhesives that aide in the sealing and reinforcement of cavities. Thermally expandable structural epoxy adhesives offer superior strength, water absorption characteristics and metal adhesion as well as favored processability for automotive assembly applications. However, the utility of expandable structural epoxy adhesives in large gap applications is limited by the large amount of heat released during ring-opening polymerization of epoxides, which can lead to peak core temperatures within the adhesive layer well above its cure temperature and, ultimately, thermal degradation of the adhesive.

A need exists for epoxy-based structural adhesive pastes that afford reduced peak core temperatures, permitting their use in large gap applications.

### SUMMARY OF THE INVENTION

In a first aspect, the invention provides an expandable adhesive composition comprising:
(A) at least one liquid epoxy resin;
(B) at least one blowing agent;
(C) at least one hardener;
(D) at least one semi-crystalline thermoplastic in particulate form.

In a second aspect, the invention provides a method of adhering a substrate, comprising the steps of:
(1) providing an expandable adhesive composition comprising:
   (A) at least one liquid epoxy resin;
   (B) at least one blowing agent;
   (C) at least one hardener;
   (D) at least one semi-crystalline thermoplastic in particulate form;
(2) applying the expandable adhesive composition to the substrate;
(3) expanding the expandable adhesive composition; and
(4) curing the expandable adhesive composition.

In a third aspect, the invention provides an adhered assembly comprising a substrate adhered with an adhesive resulting from the expansion and curing of an expandable adhesive composition comprising:
(A) at least one liquid epoxy resin;
(B) at least one blowing agent;
(C) at least one hardener;
(D) at least one semi-crystalline thermoplastic in particulate form.

### DETAILED DESCRIPTION OF THE INVENTION

The inventors have found that it is possible to achieve expandable epoxy adhesives with reduced core temperatures during curing by incorporating at least one semi-crystalline thermoplastic in particulate form. Such thermally expandable epoxy adhesive pastes can be applied robotically to oily vehicle panels to fill and reinforce cavities during an automated assembly process, thereby saving time and money. Specifically, it was found that particulate semi-crystalline thermoplastic resins, such as polyamides, copolyetheresters and polyesters, afford significant reductions in the peak core temperatures reached within the expandable epoxy pastes during cure.

### Definitions and Abbreviations

ATH aluminium trihydroxide, aluminium trihydrate
MDI 4,4′-Methylenebis(phenyl isocyanate)
HDI Hexamethylene diisocyanate
HEMA hydroxyethyl methacrylic acid
IPDI isophorone diisocyanate
PTMEG poly(tetramethylene oxide) glycol
PU polyurethane
SEC size exclusion chromatography
RH relative humidity
CF cohesive failure
AF adhesive failure
Mₚ peak molecular weight, the molecular weight of the
highest peak
FTIR Fourier transform infrared
PBT poly(butylene terephthalate)

Equivalent and molecular weights are measured by gel permeation chromatography (GPC).

### At Least One Liquid Epoxy Resin (A)

The adhesives of the invention comprise at least one liquid epoxy resin. The expression liquid epoxy resin comprises all epoxy resins that are flowable at 25° C., preferably having a viscosity at 25° C. of less than 1,500,000 mPa·s, when measured according to ASTM D-445.

In a preferred embodiment, the at least one epoxy resin comprises or consists of an epoxy resin having a viscosity at 25° C. of less than 50,000 mPa·s, more preferably less than 20,000 mPa·s, when measured according to ASTM D-445.

Examples of suitable epoxy resins are those formed by reaction of epichlorohydrin with bisphenols, in particular bisphenol A, bisphenol AP, bisphenol AF, bisphenol BP, bisphenol B, bisphenol C, bisphenol E, bisphenol F, bisphenol G, bisphenol M, bisphenol S, bisphenol P, bisphenol Z, and novolac epoxy resins, which are the reaction products of epichlorohydrin and a novolac resin. Novolac resins are made from reaction of phenol and formaldehyde, and epoxy resins resulting from reaction of various diols with epichlorohydrin (other than bisphenols), such as dihexanediol diglyciyl ether. Epoxy resin resulting from reaction of epichlorohydrin with bisphenol A are particularly preferred.

In a particularly preferred embodiment, the at least one epoxy resin comprises or consists of an epoxy resin resulting from reaction of epichlorohydrin with bisphenol A, and has a viscosity at 25° C. of less than 50,000 mPa·s, more preferably less than 20,000 mPa·s, when measured according to ASTM D-445.

In a preferred embodiment, the at least one liquid epoxy resin comprises a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), a viscosity at 25° C. of 11,000-14,000 mPas (as measured according to ASTM D-445), and a functionality of 2.

The at least one liquid epoxy resin is preferably used at 10-65 wt %, more preferably 35-60 wt %, more particularly preferably 40-55 wt %, based on the total weight of the adhesive composition.

In a preferred embodiment, the at least one epoxy resin comprises or consists of an epoxy resin having a viscosity at 25° C. of less than 1,500,000 mPa·s, when measured according to ASTM D-445, used at 10-65 wt %, more preferably 35-60 wt %, more particularly preferably 40-55 wt %, based on the total weight of the adhesive composition.

In a preferred embodiment, the at least one epoxy resin comprises or consists of an epoxy resin having a viscosity at 25° C. of less than 50,000 mPa·s, more preferably less than 20,000 mPa·s, when measured according to ASTM D-445, used at 10-65 wt %, more preferably 35-60 wt %, more particularly preferably 40-55 wt %, based on the total weight of the adhesive composition.

In another preferred embodiment, the at least one epoxy resin comprises or consists of an epoxy resin formed by reaction of epichlorohydrin with bisphenols, in particular bisphenol A, bisphenol AP, bisphenol AF, bisphenol BP, bisphenol B, bisphenol C, bisphenol E, bisphenol F, bisphenol G, bisphenol M, bisphenol S, bisphenol P, bisphenol Z, used at 10-65 wt %, more preferably 35-60 wt %, more particularly preferably 40-55 wt %, based on the total weight of the adhesive composition.

In another preferred embodiment, the at least one epoxy resin comprises or consists of an epoxy resin resulting from reaction of epichlorohydrin with bisphenol A, used at 10-65 wt %, more preferably 35-60 wt %, more particularly preferably 40-55 wt %, based on the total weight of the adhesive composition.

In another preferred embodiment, the at least one epoxy resin comprises or consists of an epoxy resin resulting from reaction of epichlorohydrin with bisphenol A, and has a viscosity at 25° C. of less than 50,000 mPa·s, more preferably less than 20,000 mPa·s, when measured according to ASTM D-445, used at 10-65 wt %, more preferably 35-60 wt %, more particularly preferably 40-55 wt %, based on the total weight of the adhesive composition.

In another embodiment, the at least one liquid epoxy resin comprises a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), a viscosity at 25° C. of 11,000-14,000 mPas (as measured according to ASTM D-445), and a functionality of 2, used at 10-65 wt %, more preferably 35-60 wt %, more particularly preferably 40-55 wt %, based on the total weight of the adhesive composition.

### At Least One Blowing Agent (B)

The adhesive composition of the invention comprises at least one blowing agent.

The blowing agent is preferably selected from physical blowing agents, which are low-boiling molecules or entrapped or encapsulated gases, and chemical blowing agents, which are molecules that decompose during curing to release gases.

Suitable physical blowing agents consist of expandable graphite, and gases (e.g. hydrocarbons, such as butane, pentanes), encapsulated in a polymeric shell, such as a poly(acrylonitrile) or an acrylate copolymer as well as low boiling point molecules, such as water, nitrogen, carbon dioxide, propanes, butanes and pentanes.

Suitable chemical blowing agents include
1. Isocyanates
2. Azo-compounds (e.g. azobisisobutyronitrile, diisopropyl azodicarboxylate, azodicarbonamide)
3. Hydrazine derivatives [e.g. 4,4′-oxybis(benzenesulfonyl-hydrazide), p-toluenesulfonyl hydrazide]
4. Semicarbazides and sulfonyl semicarbazides [e.g. p-toluenesulfonyl semicarbazide, 4,4′-oxybis(benzenesulfonyl semicarbazide), p,p-oxybisbenzene sulfonyl hydrazide]
5. N-nitroso compounds (e.g. dinitrosopentamethylenetetramine)
6. Tetrazoles (e.g. 5-phenyltetrazole, 5-aminotetrazole)
7. Poly(hydrosiloxanes)
8. Salts of carbonic and polycarboxylic acids (e.g. sodium hydrogen carbonate)
9. Peroxides (e.g. peroxyhexanoate, peroxydicarbonate)

In a preferred embodiment, the blowing agent comprises or consists of a physical blowing agent, more preferably a hydrocarbon gas encapsulated in a polymer, in particular isooctane, isobutane or isopentane, encapsulated in acrylonitrile.

In another preferred embodiment, the blowing agent comprises or consists of a chemical blowing agent, in particular an azo-compound, more particularly azodicarbonamide.

In another preferred embodiment the blowing agent is a mixture of a physical blowing agent and chemical blowing agent, for example a mixture of isooctane, isobutane or isopentane, encapsulated in acrylonitrile, with azodicarbonamide.

The blowing agent is preferably used at 0.25-10 wt %, more preferably 0.5-5 wt %, more particularly preferably 0.75-1.5 wt %, based on the total weight of the adhesive composition.

In a preferred embodiment, the blowing agent is selected from physical blowing agents, which are low-boiling molecules or entrapped or encapsulated gases, and chemical blowing agents, which are molecules that decompose during curing to release gases, used at 0.25-2.35 wt %, more preferably 0.5-2.15 wt %, more particularly preferably 0.75-1.5 wt %, based on the total weight of the adhesive composition.

In another preferred embodiment, the blowing agent is a physical blowing agent selected from expandable graphite, gases (e.g. hydrocarbons, such as butane, pentanes) encapsulated in a polymeric shell, such as an acrylate copolymer or a poly(acrylonitrile), and low boiling point molecules, such as water, nitrogen, carbon dioxide, propanes, butanes and pentanes used at 0.25-2.35 wt %, more preferably 0.5-2.15 wt %, more particularly preferably 0.75-1.5 wt %, based on the total weight of the adhesive composition.

In another preferred embodiment, the blowing agent is selected from chemical blowing agents:
1. Isocyanates
2. Azo-compounds (e.g. azobisisobutyronitrile, diisopropyl azodicarboxylate, azadicarbonamide)
3. Hydrazine derivatives [e.g. 4,4′-oxybis(benzenesulfonyl-hydrazide), p-toluenesulfonyl hydrazide]
4. Semicarbazides and sulfonyl semicarbazides [e.g. p-toluenesulfonyl semicarbazide, 4,4′-oxybis(benzenesulfonyl semicarbazide), p,p-oxybisbenzene sulfonyl hydrazide]
5. N-nitroso compounds (e.g. dinitrosopentamethylenetetramine)
6. Tetrazoles (e.g. 5-phenyltetrazole, 5-aminotetrazole)
7. Poly(hydrosiloxanes)
8. Salts of carbonic and polycarboxylic acids (e.g. sodium hydrogen carbonate)
9. Peroxides (e.g. peroxyhexanoate, peroxydicarbonate), used at 0.25-2.35 wt %, more preferably 0.5-2.15 wt %, more particularly preferably 0.75-1.5 wt %, based on the total weight of the adhesive composition.

In another preferred embodiment, the blowing agent is a physical blowing agent, more preferably a hydrocarbon gas encapsulated in a polymer, in particular a isopropane, isobutane or isopentane, encapsulated in an acrylic copolymer or polyacrylonitrile, used at 0.25-2.35 wt %, more preferably 0.5-2.15 wt %, more particularly preferably 0.75-1.5 wt %, based on the total weight of the adhesive composition.

In another preferred embodiment, the blowing agent is a mixture of a physical blowing agent and chemical blowing agent, for example a mixture of isooctane, isobutane or isopentane, encapsulated in acrylonitrile, with azodicarbonamide, wherein the physical blowing agent is used at 0.2-1 wt %, and the chemical blowing agent is used at 0.2-1 wt %, based on the total weight of the mixed adhesive.

In a particularly preferred embodiment, the blowing agent is 0.4-0.8 wt % of isooctane, isobutane or isopentane, encapsulated in acrylonitrile and 0.3-0.7 wt % azodicarbonamide.

### At Least One Hardener (C)

The adhesive composition of the invention comprises at least one hardener.

For one-component adhesives, the hardener is preferably a latent hardener, meaning a hardener that is activated on exposure to heat. Examples of latent hardeners include dicyandiamide, hydrazides and anhydride hardeners.

Dicyandiamide is particularly preferred.

Examples of suitable anhydrides include phthalic anhydride, tetrahydrophthalic anhydride, hexahydrophthalic anhydride, methyltetrahydrophthalic anhydride, methylhexahydrophthalic anhydride, methyl-5-norbornene-2,3-dicarboxylic anhydride, alkenylsuccinic anhydrides (e.g. dodecenylsuccinic anhydride), and trimellitic anhydride.

Examples of suitable hydrazides include adipic dihydrazide, sebacic dihydrazide, dodecanedihydrazide, isophthalic dihydrazide, and salicyclic dihydrazide.

For two-component adhesives, in which an epoxy component and a hardener component are mixed immediately prior to use, the hardener may be latent, as described above, or it may be a non-latent hardener. Examples of non-latent hardeners include polyamines, substituted triazines, imidazoles, polycarboxylic acids, polyols and polyamides.

Examples of suitable polyamines include aliphatic polyamines, cycloaliphatic polyamines, aromatic polyamines, polyether-based polyamines, polyethylenimines and polyamine derivatives.

Examples of aliphatic polyamines include diethylene triamine, triethylene tetramine (TETA), triethylenediamine, tetraethylene pentamine, dipropenediamine, diethylaminopropylamine, N-aminoethylpiperazine, menthanediamine, isophoronediamine, and derivatives of these polyamines.

Examples of polyether-based polyamines include those based on poly(propylene oxide), such as those of the following structures:

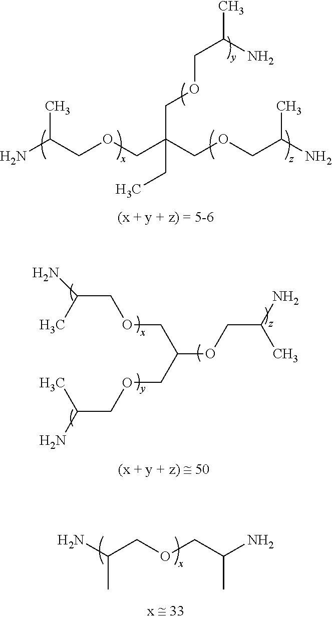

In a preferred embodiment, the hardener is a latent hardener.

In another preferred embodiment, the hardener is dicyandiamide.

In another preferred embodiment, the hardener is a latent hardener, used at 0.5-8 wt %, more preferably 1-6 wt %, particularly preferably 3-5 wt %, based on the total weight of the adhesive composition.

In another preferred embodiment, the hardener is selected from dicyandiamide, hydrazines and anhydride hardeners, used at 0.5-8 wt %, more preferably 1-6 wt %, particularly preferably 3-5 wt %, based on the total weight of the adhesive composition.

In another preferred embodiment, the hardener is dicyandiamide used at 0.5-8 wt %, more preferably 1-6 wt %, particularly preferably 3-5 wt %, based on the total weight of the adhesive composition.

In another preferred embodiment, the hardener is a non-latent hardener selected from polyamines, polyamides, substituted triazines, imidazoles, polycarboxylic acids and polyols used at 0.5-50 wt %, more preferably 20-50 wt %, particularly preferably 30-50 wt %. In the case of a two-component (2K) adhesive, these concentrations refer to the adhesive mixture resulting from mixing the epoxy component and the hardener component.

Examples of suitable polyamines include aliphatic polyamines, cycloaliphatic polyamines, aromatic polyamines, polyether-based polyamines, polyethylenimines, used at 0.5-50 wt %, more preferably 20-50 wt %, particularly preferably 30-50 wt %. In the case of a two-component (2K) adhesive, these concentrations refer to the adhesive mixture resulting from mixing the epoxy component and the hardener component.

Examples of aliphatic polyamines include diethylene triamine, triethylene tetramine (TETA), triethylenediamine, tetraethylene pentamine, dipropenediamine, diethylaminopropylamine, N-aminoethylpiperazine, menthanediamine, isophoronediamine, used at 0.5-50 wt %, more preferably 20-50 wt %, particularly preferably 30-50 wt %. In the case of a two-component (2K) adhesive, these concentrations refer to the adhesive mixture resulting from mixing the epoxy component and the hardener component.

Examples of polyether-based polyamines include those based on poly(propylene oxide), such as those of the following structures:

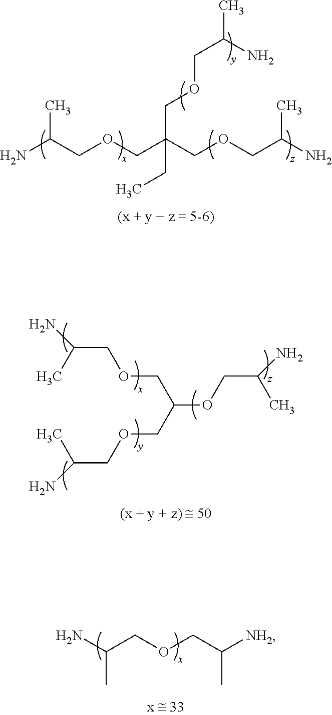

used at 0.5-50 wt %, more preferably 20-50 wt %, particularly preferably 30-50 wt %. In the case of a two-component (2K) adhesive, these concentrations refer to the adhesive mixture resulting from mixing the epoxy component and the hardener component.

### At Least One Semi-Crystalline Thermoplastic (D)

The adhesive of the invention comprises one or more semi-crystalline thermoplastic polymers in particulate form.

In a preferred embodiment, the at least one semi-crystalline thermoplastic polymers has a melting temperature between 140-200° C., more preferably 150-190° C.

In a preferred embodiment, the one or more thermoplastic polymers has an average particle size of less than 100 μm.

In a preferred embodiment, the one or more thermoplastic polymers has an average particle size of greater than 5 μm.

In a preferred embodiment, the one or more thermoplastic polymers has an average particle size of 5-100 μm.

In another preferred embodiment, the one or more thermoplastic polymers is in the form of powder, in a particular a powder having average particle size of less than 100 μm, and having a melting temperature between 140-200° C., more preferably 150-190° C.

Examples of suitable thermoplastics include polyamides, polyesters and copolyetheresters, preferably in powder form.

In a preferred embodiment, the adhesive composition comprises polyamide, in particular a long-chain polyamide. Suitable long-chain polyamides include those made from a diacid, a diamine or a lactam or amino-carboxylic acid having 6-12 carbon atoms, preferably in powder form. Examples include PA66, PA6, PA11, PA12, PA410, PA610, PA1010, PA612, PA1212, preferably in powder form.

In a particularly preferred embodiment, the adhesive composition comprises a polyamide selected from PA12, PA11, PA610, PA1010, PA612, PA1212, and mixtures of these, preferably in powder form, with PA12 being particularly preferred, preferably in powder form.

In a preferred embodiment, the adhesive composition comprises copolyetherester, preferably in powder form, in particular a copolyetherester comprising PBT hard segments and PTMEG soft segments, preferably in powder form.

In a preferred embodiment, the adhesive composition comprises polyester, preferably in powder form, in particular PBT, preferably in powder form.

For two-component adhesive compositions (2K), comprising an epoxy component and a hardener component, the thermoplastic may be compounded with either component or both.

If used, the thermoplastic is preferably used at 5-30 wt %, more preferably 7-22 wt %, particular preferably 8-15 wt %, based on the total weight of the adhesive composition.

In a preferred embodiment, the one or more thermoplastic polymers is in the form of powder, in a particular a powder having average particle size of less than 100 μm, and is used at 5-30 wt %, more preferably 7-22 wt %, particular preferably 8-15 wt %, based on the total weight of the adhesive composition.

In another preferred embodiment, the one or more thermoplastic polymers has a melting temperature between 140-200° C., more preferably 150-190° C., and is used at 5-30 wt %, more preferably 7-22 wt %, particular preferably 8-15 wt %, based on the total weight of the adhesive composition.

In another preferred embodiment, the one or more thermoplastic polymers is in the form of powder, in a particular a powder having average particle size of less than 100 μm, and has a melting temperature between 140-200° C., more preferably 150-190° C., and is used at 5-30 wt %, more preferably 7-22 wt %, particular preferably 8-15 wt %, based on the total weight of the adhesive composition.

In another preferred embodiment, the thermoplastic is selected from polyamides, polyesters and copolyetheresters, preferably in powder form, used at 5-30 wt %, more preferably 7-22 wt %, particular preferably 8-15 wt %, based on the total weight of the adhesive composition.

In another preferred embodiment, the adhesive composition comprises polyamide, in particular a polyamide made from a diacid, a diamine or a lactam or amino-carboxylic acid having 6-12 carbon atoms, preferably in powder form, used at 5-30 wt %, more preferably 7-22 wt %, particular preferably 8-15 wt %, based on the total weight of the adhesive composition.

In another preferred embodiment, the thermoplastic is selected from PA66, PA6, PA11, PA12, PA410, PA610, PA1010, PA612, PA1212, preferably in powder form, used at 5-30 wt %, more preferably 7-22 wt %, particular preferably 8-15 wt %, based on the total weight of the adhesive composition.

In another preferred embodiment, the thermoplastic is selected from PA12, PA11, PA610, PA1010, PA612, PA1212, and mixtures of these, preferably in powder form, used at 5-30 wt %, more preferably 7-22 wt %, particular preferably 8-15 wt %, based on the total weight of the adhesive composition.

In another preferred embodiment, the thermoplastic is selected from PA12's, preferably in powder form, used at 5-30 wt %, more preferably 7-22 wt %, particular preferably 8-15 wt %, based on the total weight of the adhesive composition.

In another preferred embodiment, the adhesive composition comprises copolyetherester, preferably in powder form, used at 5-30 wt %, more preferably 7-22 wt %, particular preferably 8-15 wt %, based on the total weight of the adhesive composition.

In another preferred embodiment, the adhesive composition comprises a copolyetherester selected from those comprising PBT hard segments and PTMEG soft segments, preferably in powder form, used at 5-30 wt %, more preferably 7-22 wt %, particular preferably 8-15 wt %, based on the total weight of the adhesive composition.

In another preferred embodiment, the adhesive composition comprises polyester, preferably in powder form, used at 5-30 wt %, more preferably 7-22 wt %, particular preferably 8-15 wt %, based on the total weight of the adhesive composition.

In another preferred embodiment, the adhesive composition comprises PBT, preferably in powder form, used at 5-30 wt %, more preferably 7-22 wt %, particular preferably 8-15 wt %, based on the total weight of the adhesive composition.

### Optional Ingredients

The adhesives of the invention may contain additional optional ingredients, such as, for example:

1. One or more tougheners: Tougheners are elastomeric molecules that are compatible with the epoxy matrix and which impart impact resistance and elasticity on the hardened adhesive. Examples include polyurethane-based tougheners, rubber-based tougheners, core-shell rubber tougheners. In a preferred embodiment, the at least one toughener is selected from those molecules bearing terminal functional groups that can react with the epoxy matrix during polymerization. Suitable tougheners include polyurethane-based tougheners in which the terminal NCO groups are uncapped or capped (for example, with a phenol or polyphenol), polybutadiene-based tougheners terminated with amine or diol functionality. In a preferred embodiment, the at least one toughener is selected from polyurethane tougheners, in particular those in which the terminal NCO groups are capped with phenol groups, in particular cardanol.

In a particularly preferred embodiment, the at least one toughener is prepared by reacting a polybutadiene diol, a polyetherdiol and a diisocyanate, such that the resulting molecule bears terminal NCO groups. This kind of toughener may be used as is, or it may be capped with a phenol or polyphenol. In a preferred embodiment, it is end-capped with cardanol.

If used, the at least one toughener is preferably used at 3-25 wt %, more preferably 12-18 wt %, based on the total weight of the adhesive.

In a preferred embodiment, the toughener is selected from polyurethane-based tougheners, rubber-based tougheners, and core-shell rubber tougheners, used at 3-25 wt %, more preferably 12-18 wt %, based on the total weight of the adhesive.

In another preferred embodiment, the at least one toughener is selected from those molecules bearing terminal functional groups that can react with the epoxy matrix during polymerization, used at 3-25 wt %, more preferably 12-18 wt %, based on the total weight of the adhesive.

In another preferred embodiment, the at least one toughener polyurethane-based tougheners in which the terminal NCO groups are uncapped or capped (for example, with a phenol or polyphenol), polybutadiene-based tougheners terminated with amine or diol functionality, used at 3-25 wt %, more preferably 12-18 wt %, based on the total weight of the adhesive.

In another preferred embodiment, the at least one toughener is selected from polyurethane tougheners, in which the terminal NCO groups are capped with phenol groups, in particular cardanol, used at 3-25 wt %, more preferably 12-18 wt %, based on the total weight of the adhesive.

In a particularly preferred embodiment, the at least one toughener is prepared by reacting a polybutadiene diol, a polyetherdiol and a diisocyanate, such that the resulting molecule bears terminal NCO groups, used at 3-25 wt %, more preferably 12-18 wt %, based on the total weight of the adhesive.

In another particularly preferred embodiment, the at least one toughener is prepared by reacting a polybutadiene diol, a polyetherdiol and a diisocyanate, such that the resulting molecule bears terminal NCO groups, followed by end-capping with cardanol, used at 3-25 wt %, more preferably 12-18 wt %, based on the total weight of the adhesive.

2. One or more silane adhesion promoters: The adhesive compositions of the invention may comprise one or more silane adhesion promoters.

Preferred silane adhesion promoters are of the general Formula I:

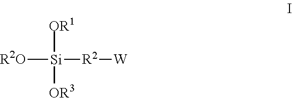

where R¹, R² and R³ are independently selected from C₁-C₄-alkyl, R² is a divalent C₂-C₆-alkylene radical, and W is glycidyl, amino or mercapto.

In a preferred embodiment, in Formula I, W is glycidyl.

In another preferred embodiment, in Formula I, R¹, R² and R³ are methyl and R² is propylene.

In another preferred embodiment, in Formula I, R¹, R² and R³ are methyl, R² is propylene, and W is glycidyl.

In a preferred embodiment, the adhesive composition of the invention comprises gamma-glycidylpropyltrimethoxysilane.

When used, the silane adhesion promoter is preferably present at 0.05-1 wt %, more preferably 0.1-0.75 wt %, more particularly preferably 0.2-0.4 wt %, based on the total weight of the adhesive composition.

Preferably the at least one silane adhesion promoter is of the general Formula I:

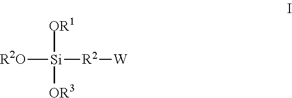

where R¹, R² and R³ are independently selected from C₁-C₄-alkyl, R² is a divalent C₂-C₆-alkylene radical, and W is glycidyl, amino or mercapto, used at 0.05-1 wt %, more preferably 0.1-0.75 wt %, more particularly preferably 0.2-0.4 wt %, based on the total weight of the adhesive composition.

In a preferred embodiment, in Formula I, W is glycidyl, and the adhesion promoter is used at 0.05-1 wt %, more preferably 0.1-0.75 wt %, more particularly preferably 0.2-0.4 wt %, based on the total weight of the adhesive composition.

In another preferred embodiment, in Formula I, R¹, R² and R³ are methyl and R² is propylene, and the adhesion promoter is used at 0.05-1 wt %, more preferably 0.1-0.75 wt %, more particularly preferably 0.2-0.4 wt %, based on the total weight of the adhesive composition.

In another preferred embodiment, in Formula I, R¹, R² and R³ are methyl, R² is propylene, and W is glycidyl, and the adhesion promoter is used at 0.05-1 wt %, more preferably 0.1-0.75 wt %, more particularly preferably 0.2-0.4 wt %, based on the total weight of the adhesive composition.

In a preferred embodiment, the adhesive composition of the invention comprises gamma-glycidylpropyltrimethoxysilane, used at 0.05-1 wt %, more preferably 0.1-0.75 wt %, more particularly preferably 0.2-0.4 wt %, based on the total weight of the adhesive composition.

3. One or more epoxy polymerization catalysts: The adhesive compositions of the invention optionally comprise one or more epoxy polymerization catalysts.

Epoxy polymerization catalysts may be a Lewis base or a Lewis acid. Examples of Lewis bases include tertiary amines and imidazoles.

Examples of Lewis acids include BF₃, ZnCl₂, SnCl₄, FeCl₃, AlCl₃, boron trifluoride complex.

In a preferred embodiment, the catalyst is a Lewis base, more preferably a tertiary amine.

Examples of suitable tertiary amines include 2,4,6-Tris(dimethylaminomethyl)phenol, tetramethylguanidine, heptamethylisobiguanide, N,N-dimethylbenzylamine

In another preferred embodiment, the catalyst is 2,4,6-Tris(dimethylaminomethyl)phenol, in particular 2,4,6-Tris(dimethylaminomethyl)phenol on a novolac support.

For two-component adhesives, comprising an epoxy component and a hardener component, the catalyst is formulated with the hardener component.

The catalyst is preferably used at 0.25-1.2 wt %, more preferably 0.5-1 wt %, based on the total weight of the adhesive composition.

In a preferred embodiment, the catalyst is a Lewis base, used at 0.25-1.2 wt %, more preferably 0.5-1 wt %, based on the total weight of the adhesive composition.

In a preferred embodiment, the catalyst is a Lewis acid, used at 0.25-1.2 wt %, more preferably 0.5-1 wt %, based on the total weight of the adhesive composition.

In another preferred embodiment, the catalyst is selected from tertiary amines and imidazoles, used at 0.25-1.2 wt %, more preferably 0.5-1 wt %, based on the total weight of the adhesive composition.

In another preferred embodiment, the catalyst is selected from BF₃, ZnCl₂, SnCl₄, FeCl₃, AlCl₃, and boron trifluoride complex, used at 0.25-1.2 wt %, more preferably 0.5-1 wt %, based on the total weight of the adhesive composition.

In another preferred embodiment, the catalyst is a tertiary amine, used at 0.25-1.2 wt %, more preferably 0.5-1 wt %, based on the total weight of the adhesive composition.

In another preferred embodiment, the catalyst is selected from 2,4,6-Tris(dimethylaminomethyl)phenol, tetramethylguanidine, heptamethylisobiguanide, N,N-dimethylbenzylamine, used at 0.25-1.2 wt %, more preferably 0.5-1 wt %, based on the total weight of the adhesive composition.

In another preferred embodiment, the catalyst is 2,4,6-Tris(dimethylaminomethyl)phenol, in particular 2,4,6-Tris(dimethylaminomethyl)phenol on a novolac support, used at 0.25-1.2 wt %, more preferably 0.5-1 wt %, based on the total weight of the adhesive composition.

4. One or more thermally-conductive fillers: The adhesive compositions of the invention optionally comprise at least one thermally conductive filler.

Suitable thermally conductive fillers are those that have a coefficient of thermal conductivity that is greater than 5 W/m° K, greater than 10 W/m° K, or greater than 15 W/m° K. Examples of thermally conductive fillers include alumina, alumina trihydrate or aluminum trihydroxide (ATH), silicon carbide, boron nitride, diamond, and graphite, and mixtures thereof. Particularly preferred are aluminium trihydroxide (ATH), and aluminium oxide, with ATH being the most preferred. Also preferred is a mixture of ATH and alumina, in particular with a wt:wt ratio of ATH:alumina of 8-15. Thermally-conductive fillers may be surface treated or non-treated.

In a preferred embodiment, the thermally conductive filler has a broad particle size distribution characterized by a ratio of D90/D50 of at or about 3 or more. Particularly preferably the thermally conductive filler is ATH or aluminium oxide having a broad particle size distribution characterized by a ratio of D90/D50 of at or about 3 or more, most preferably ATH.

Also preferred are thermally conductive fillers having a bimodal particle size distribution. A bimodal distribution is when, for example, the ratio D90/D50 is at or about 3 or more, more preferably at or about 5 or more, more particularly preferably at or about 9 or more. For example, particles having a D50 of 5 to 20 microns and a D90 of 70 to 90 microns, particularly a D50 of 7-9 microns and a D90¬ of 78-82 microns. Particle size can be determined using laser diffraction. For ATH a suitable solvent is deionized water containing a dispersion aid, such as Na4P2O7×10 H2O, preferably at 1 g/l.

Preferred are aluminium oxide and ATH having a bimodal distribution, particularly ATH. In a preferred embodiment, the thermally conductive filler is ATH having D90/D50 at or about 3 or more, more preferably at or about 5 or more, particularly preferably at or about 9 or more.

In a preferred embodiment, the thermally conductive filler is bimodally distributed aluminium trihydroxide (ATH), having the following particle size distribution (by laser diffraction in deionized water containing a dispersion aid, such as Na₄P₂O₇×10 H₂O, preferably at 1 g/l):
D₁₀ (micron) 0.5
D₅₀ (micron) 8
D₉₀ (micron) 80.

The thermally conductive filler is preferably present in the final adhesive at a concentration of 10-55 wt %, more preferably 15-45 wt %, more particularly preferably 20-42 wt %, based on the total weight of the adhesive. In the case of a two-component (2K) adhesive, these concentrations refer to the adhesive mixture resulting from mixing the epoxy component and the hardener component.

In a preferred embodiment, the thermally-conductive filler is aluminium trihydroxide (ATH), used at a concentration of 10-55 wt %, more preferably 15-45 wt %, more particularly preferably 20-42 wt %, based on the total weight of the adhesive. In the case of a two-component (2K) adhesive, these concentrations refer to the adhesive mixture resulting from mixing the epoxy component and the hardener component.

In another preferred embodiment, the thermally-conductive filler is aluminium trihydroxide (ATH), having the following particle size distribution (by laser diffraction in deionized water containing a dispersion aid, such as Na₄P₂O₇×10 H₂O, preferably at 1 g/l):
D₁₀ (micron) 0.5
D₅₀ (micron) 8
D₉₀ (micron) 80
   used at a concentration of 10-55 wt %, more preferably 15-45 wt %, more particularly preferably 20-42 wt %, based on the total weight of the adhesive. In the case of a two-component (2K) adhesive, these concentrations refer to the adhesive mixture resulting from mixing the epoxy component and the hardener component.

5. Non-thermally conductive fillers: The adhesive composition of the invention may optionally comprise non-thermally-conductive fillers, such as, for example, calcium carbonate, fumed silica, clay,

### Method of Manufacture

For one-component adhesives (1K), the ingredients are simply mixed together to homogeneity.

In a preferred method of manufacture, the epoxy ingredients, silane adhesion promoter (if used) and toughener (if used) are mixed together to substantial homogeneity. The thermally-conductive filler and other fillers (if used) are added and mixed. The blowing agent is added, as well as the epoxy polymerization catalyst (if used) and the hardener is added and the mixture is mixed to homogeneity.

For two-component adhesives, the epoxy ingredients, silane adhesion promoter (if used) and toughener (if used) are mixed together to substantial homogeneity. The thermally-conductive filler and other fillers (if used) are added and mixed. This mixture forms the first component (epoxy component). The hardener, epoxy polymerization catalyst (if used), blowing agent and thermally-conductive filler and other fillers (if used) are mixed to homogeneity to form the second component (hardener component).

### Method of Use

The invention also provides a method of adhering a substrate, comprising the steps of:
(1) providing an expandable adhesive composition comprising:
   (A) at least one liquid epoxy resin;
   (B) at least one blowing agent;
   (C) at least one hardener;
   (D) at least one semi-crystalline thermoplastic in particulate form;
(2) applying the expandable adhesive composition to the substrate;
(3) expanding the expandable adhesive composition; and
(4) curing the expandable adhesive composition.

The adhesive may be applied to the substrate by any method, including spreading and application through a nozzle, with application through a nozzle being particularly preferred.

Expansion is typically carried out by heating, which also initiates curing of the adhesive. Heating may be carried out using any heating method, for example, an oven, IR radiation or RF radiation.

Heating is preferably carried out to at least 120° C. Heating may be to 150, 160, 170 or 180° C. Curing of epoxy resins is exothermic, so once curing begins, heating may no longer be necessary.

### Effect of the Invention

The adhesives of the invention show decreased 12 mm peak core temperatures as compared to adhesives not comprising thermally-conductive filler, and/or as compared to adhesives not comprising thermoplastic polymer, when measured using the method recited in the Examples.

Preferably the adhesives compositions of the invention show 12 mm peak core temperatures of 275° C. or less, more preferably 260° C. or less, when measured using the method recited in the Examples.

The adhesive compositions of the invention preferably show a percent expansion of 130% or more.

In a preferred embodiment, the adhesive compositions of the invention show 12 mm peak core temperatures of 275° C. or less, more preferably 260° C. or less, when measured using the method recited in the Examples, and a percent expansion of 130% or more.

### Applications

The adhesives of the invention are particularly suited to bond metal substrates and fill cavities in automotive body shops in order to create robust composite assemblies.

### PARTICULARLY PREFERRED EMBODIMENTS

The following are particularly preferred embodiments of the invention:
1. An expandable adhesive composition comprising:
   (A) at least one liquid epoxy resin;
   (B) at least one blowing agent;
   (C) at least one hardener;
   (D) at least one semi-crystalline thermoplastic in particulate form.
2. A method of adhering a substrate, comprising the steps of:
   (1) providing an expandable adhesive composition comprising:
      (A) at least one liquid epoxy resin;
      (B) at least one blowing agent;
      (C) at least one hardener;
      (D) at least one semi-crystalline thermoplastic in particulate form;
   (2) applying the expandable adhesive composition to the substrate; (3) expanding the expandable adhesive composition; and
   (4) curing the expandable adhesive composition.
3. An adhered assembly comprising a substrate adhered with an adhesive resulting from the expansion and curing of an expandable adhesive composition comprising:
   (A) at least one liquid epoxy resin;
   (B) at least one blowing agent;
   (C) at least one hardener;
   (D) at least one semi-crystalline thermoplastic in particulate form.
4. An expandable adhesive composition comprising:
   (A) at least one liquid epoxy resin;
   (B) at least one blowing agent;
   (C) at least one hardener;
   (D) at least one semi-crystalline thermoplastic in particulate form;
   (E) at least one thermally-conductive filler.
5. A method of adhering a substrate, comprising the steps of:
   (1) providing an expandable adhesive composition comprising:
      (A) at least one liquid epoxy resin;
      (B) at least one blowing agent;
      (C) at least one hardener;
      (D) at least one semi-crystalline thermoplastic in particulate form;
      (E) at least one thermally-conductive filler;
   (2) applying the expandable adhesive composition to the substrate;
   (3) expanding the expandable adhesive composition; and
   (4) curing the expandable adhesive composition.
6. An adhered assembly comprising a substrate adhered with an adhesive resulting from the expansion and curing of an expandable adhesive composition comprising:
   (A) at least one liquid epoxy resin;
   (B) at least one blowing agent;
   (C) at least one hardener;
   (D) at least one semi-crystalline thermoplastic in particulate form;
   (E) at least one thermally-conductive filler.
7. Any one preceding embodiment, wherein the liquid epoxy resin comprises all epoxy resins that are flowable at 25° C., preferably having a viscosity at 25° C. of less than 1,500,000 mPas, when measured according to ASTM D-445.
8. Any one preceding embodiment, wherein the at least one epoxy resin comprises or consists of an epoxy resin having a viscosity at 25° C. of less than 50,000 mPa·s, more preferably less than 20,000 mPa·s, when measured according to ASTM D-445.
9. Any one preceding embodiment, wherein the epoxy resin comprises or consists of an epoxy resin selected from are those formed by reaction of epichlorohydrin with bisphenols, in particular bisphenol A, bisphenol AP, bisphenol AF, bisphenol BP, bisphenol B, bisphenol C, bisphenol E, bisphenol F, bisphenol G, bisphenol M, bisphenol S, bisphenol P, bisphenol Z.
10. Any one preceding embodiment, wherein the epoxy resin comprises or consists of an epoxy resin selected from epoxy resins resulting from reaction of epichlorohydrin with bisphenol A.
11. Any one preceding embodiment, wherein the at least one epoxy resin comprises or consists of an epoxy resin resulting from reaction of epichlorohydrin with bisphenol A, and has a viscosity at 25° C. of less than 50,000 mPa·s, more preferably less than 20,000 mPa·s, when measured according to ASTM D-445.
12. Any one preceding embodiment, wherein the at least one liquid epoxy resin comprises a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), a viscosity at 25° C. of 11,000-14,000 mPas (as measured according to ASTM D-445), and a functionality of 2.
13. Any one preceding embodiment, wherein the at least one liquid epoxy resin is used at 10-65 wt %, more preferably 35-60 wt %, more particularly preferably 40-55 wt %, based on the total weight of the adhesive composition.
14. Any one preceding embodiment, wherein the at least one epoxy resin comprises or consists of an epoxy resin having a viscosity at 25° C. of less than 1,500,000 mPas, when measured according to ASTM D-445, used at 10-65 wt %, more preferably 35-60 wt %, more particularly preferably 40-55 wt %, based on the total weight of the adhesive composition.
15. Any one preceding embodiment, wherein the at least one epoxy resin comprises or consists of an epoxy resin having a viscosity at 25° C. of less than 50,000 mPa·s, more preferably less than 20,000 mPa·s, when measured according to ASTM D-445, used at 10-65 wt %, more preferably 35-60 wt %, more particularly preferably 40-55 wt %, based on the total weight of the adhesive composition.
16. Any one preceding embodiment, wherein the at least one epoxy resin comprises or consists of an epoxy resin formed by reaction of epichlorohydrin with bisphenols, in particular bisphenol A, bisphenol AP, bisphenol AF, bisphenol BP, bisphenol B, bisphenol C, bisphenol E, bisphenol F, bisphenol G, bisphenol M, bisphenol S, bisphenol P, bisphenol Z, used at 10-65 wt %, more preferably 35-60 wt %, more particularly preferably 40-55 wt %, based on the total weight of the adhesive composition.
17. Any one preceding embodiment, wherein the at least one epoxy resin comprises or consists of an epoxy resin resulting from reaction of epichlorohydrin with bisphenol A, used at 10-65 wt %, more preferably 35-60 wt %, more particularly preferably 40-55 wt %, based on the total weight of the adhesive composition.
18. Any one preceding embodiment, wherein the at least one epoxy resin comprises or consists of an epoxy resin resulting from reaction of epichlorohydrin with bisphenol A, and has a viscosity at 25° C. of less than 50,000 mPa·s, more preferably less than 20,000 mPa·s, when measured according to ASTM D-445, used at 30-65 wt %, more preferably 35-60 wt %, more particularly preferably 40-55 wt %, based on the total weight of the adhesive composition.
19. Any one preceding embodiment, wherein the at least one liquid epoxy resin comprises a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), a viscosity at 25° C. of 11,000-14,000 mPas (as measured according to ASTM D-445), and a functionality of 2, used at 10-65 wt %, more preferably 35-60 wt %, more particularly preferably 40-55 wt %, based on the total weight of the adhesive composition.
20. Any one preceding embodiment, wherein the blowing agent is selected from physical blowing agents, which are low-boiling molecules or entrapped or encapsulated gases, and chemical blowing agents, which are molecules that decompose during curing to release gases.
21. Any one preceding embodiment, wherein the blowing agent is selected from expandable graphite, and gases (e.g. hydrocarbons, such as butane, pentanes), encapsulated in a polymeric shell, such as poly(acrylonitriles) and acrylate copolymers, as well as low boiling point molecules, such as water, nitrogen, carbon dioxide, propanes, butanes and pentanes.
22. Any one preceding embodiment, wherein the blowing agent is selected from:
   1. Isocyanates
   2. Azo-compounds (e.g. azobisisobutyronitrile, diisopropyl azodicarboxylate, azadicarbonamide)
   3. Hydrazine derivatives [e.g. 4,4′-oxybis(benzenesulfonyl-hydrazide), p-toluenesulfonyl hydrazide]
   4. Semicarbazides and sulfonyl semicarbazides [e.g. p-toluenesulfonyl semicarbazide, 4,4′-oxybis(benzenesulfonyl semicarbazide), p,p-oxybisbenzene sulfonyl hydrazide]
   5. N-nitroso compounds (e.g. dinitrosopentamethylenetetramine)
   6. Tetrazoles (e.g. 5-phenyltetrazole, 5-aminotetrazole)
   7. Poly(hydrosiloxanes)
   8. Salts of carbonic and polycarboxylic acids (e.g. sodium hydrogen carbonate)
   9. Peroxides (e.g. peroxyhexanoate, peroxydicarbonate)
23. Any one preceding embodiment, wherein the blowing agent is a physical blowing agent, more preferably a hydrocarbon gas encapsulated in a polymer, in particular a propane, butane or pentane, encapsulated in poly(acrylonitriles) and/or acrylate copolymers.
24. Any one preceding embodiment, wherein the blowing agent is selected from a propane, butane or pentane, encapsulated in poly(acrylonitriles) and/or acrylate copolymers.
25. Any one preceding embodiment, wherein the blowing agent is used at 0.25-2.35 wt %, more preferably 0.5-2.15 wt %, more particularly preferably 0.75-1.5 wt %, based on the total weight of the adhesive composition.
26. Any one preceding embodiment, wherein the blowing agent is selected from physical blowing agents, which are low-boiling molecules or entrapped or encapsulated gases, and chemical blowing agents, which are molecules that decompose during curing to release gases, used at 0.25-2.35 wt %, more preferably 0.5-2.15 wt %, more particularly preferably 0.75-1.5 wt %, based on the total weight of the adhesive composition.
27. Any one preceding embodiment, wherein the blowing agent is a physical blowing agent selected from expandable graphite, gases (e.g. hydrocarbons, such as butane, pentanes) encapsulated in a polymeric shell, such as poly(acrylonitriles) and acrylate copolymers, and low boiling point molecules, such as water, nitrogen, carbon dioxide, propanes, butanes and pentanes used at 0.25-2.35 wt %, more preferably 0.5-2.15 wt %, more particularly preferably 0.75-1.5 wt %, based on the total weight of the adhesive composition.
28. Any one preceding embodiment, wherein the blowing agent is selected from chemical blowing agents:
   1. Isocyanates
   2. Azo-compounds (e.g. azobisisobutyronitrile, diisopropyl azodicarboxylate, azadicarbonamide)
   3. Hydrazine derivatives [e.g. 4,4′-oxybis(benzenesulfonyl-hydrazide), p-toluenesulfonyl hydrazide]
   4. Semicarbazides and sulfonyl semicarbazides [e.g. p-toluenesulfonyl semicarbazide, 4,4′-oxybis(benzenesulfonyl semicarbazide), p,p-oxybisbenzene sulfonyl hydrazide]
   5. N-nitroso compounds (e.g. dinitrosopentamethylenetetramine)
   6. Tetrazoles (e.g. 5-phenyltetrazole, 5-aminotetrazole)
   7. Poly(hydrosiloxanes)
   8. Salts of carbonic and polycarboxylic acids (e.g. sodium hydrogen carbonate)
   9. Peroxides (e.g. peroxyhexanoate, peroxydicarbonate), used at 0.25-2.35 wt %, more preferably 0.5-2.15 wt %, more particularly preferably 0.75-1.5 wt %, based on the total weight of the adhesive composition.
29. Any one preceding embodiment, wherein the blowing agent is a hydrocarbon gas encapsulated in a polymer, in particular a propane, butane or pentane, encapsulated in poly(acrylonitriles) and/or acrylate copolymers, used at 0.25-2.35 wt %, more preferably 0.5-2.15 wt %, more particularly preferably 0.75-1.5 wt %, based on the total weight of the adhesive composition.
30. Any one preceding embodiment, wherein the hardener is a latent hardener, meaning a hardener that is activated on exposure to heat.
31. Any one preceding embodiment, wherein the hardener is selected from dicyandiamide, hydrazides and anhydride hardeners.
32. Any one preceding embodiment, wherein the hardener is dicyandiamide.
33. Any one preceding embodiment, wherein the hardener is selected from phthalic anhydride, tetrahydrophthalic anhydride, hexahydrophthalic anhydride, methyltetrahydrophthalic anhydride, methylhexahydrophthalic anhydride, methyl-5-norbornene-2,3-dicarboxylic anhydride, alkenylsuccinic anhydrides (e.g. dodecenylsuccinic anhydride), and trimellitic anhydride
34. Any one preceding embodiment, wherein the hardener is selected from adipic dihydrazide, sebacic dihydrazide, dodecanedihydrazide, isophthalic dihydrazide, and salicyclic dihydrazide.
35. Any one preceding embodiment, wherein the adhesive is a two-component adhesives, in which an epoxy component and a hardener component are mixed immediately prior to use, and the hardener is selected from polyamines, substituted triazines, imidazoles, and polycarboxylic acids.
36. Embodiment 35, wherein the hardener is selected from aliphatic polyamines, cycloaliphatic polyamines, aromatic polyamines, polyether-based polyamines, polyethylenimines.
37. Embodiment 35, wherein the hardener is selected from diethylene triamine, triethylene tetramine (TETA), triethylenediamine, tetraethylene pentamine, dipropenediamine, diethylaminopropylamine, N-aminoethylpiperazine, menthanediamine, isophoronediamine.
38. Embodiment 35, wherein the hardener is selected from those based on poly(propylene oxide), such as those of the following structures:

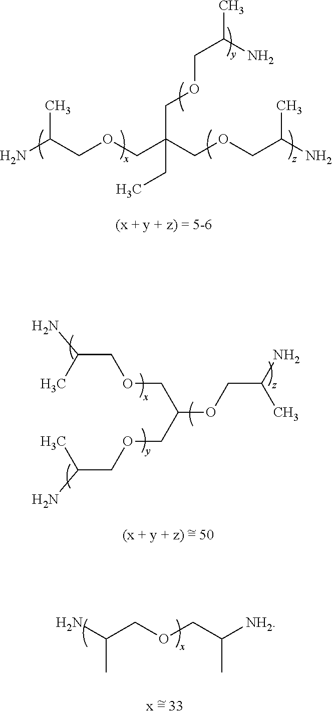

39. Any one preceding embodiment, wherein the hardener is a latent hardener.
40. Any one preceding embodiment, wherein the hardener is dicyandiamide.
41. Any one preceding embodiment, wherein the hardener is a latent hardener, used at 0.5-8 wt %, more preferably 1-6 wt %, particularly preferably 3-5 wt %, based on the total weight of the adhesive composition.
42. Any one preceding embodiment, wherein the hardener is selected from dicyandiamide, hydrazines and anhydride hardeners, used at 0.5-8 wt %, more preferably 1-6 wt %, particularly preferably 3-5 wt %, based on the total weight of the adhesive composition.
43. Any one preceding embodiment, wherein the hardener is dicyandiamide used at 0.5-8 wt %, more preferably 1-6 wt %, particularly preferably 3-5 wt %, based on the total weight of the adhesive composition.
44. Any one preceding embodiment, wherein the hardener is a non-latent hardener selected from polyamines, polyamides, substituted triazines, imidazoles, polyols and polycarboxylic acids, used at 0.5-50 wt %, more preferably 20-50 wt %, particularly preferably 30-50 wt %, based on the total weight of the mixed adhesive composition.
45. Any one preceding embodiment, wherein the hardener is selected from cycloaliphatic amines, aromatic amines, polyether-based polyamines, polyethylenimines, used at 0.5-50 wt %, more preferably 20-50 wt %, particularly preferably 30-50 wt %, based on the total weight of the mixed adhesive composition.
46. Any one preceding embodiment, wherein the hardener is selected from diethylene triamine, triethylene tetramine (TETA), triethylenediamine, tetraethylene pentamine, dipropenediamine, diethylaminopropylamine, N-aminoethylpiperazine, menthanediamine, isophoronediamine, used at 0.5-50 wt %, more preferably 20-50 wt %, particularly preferably 30-50 wt %, based on the total weight of the mixed adhesive composition.
47. Any one preceding embodiment, wherein the hardener is selected from those based on poly(propylene oxide), such as those of the following structures:

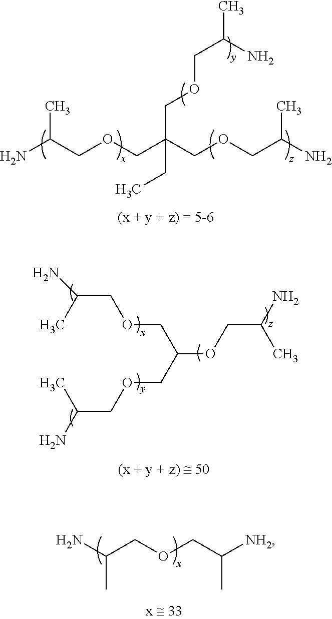

used at 0.5-50 wt %, more preferably 20-50 wt %, particularly preferably 30-50 wt %, based on the total weight of the mixed adhesive composition.
48. Any one preceding embodiment, which additionally comprises a thermally conductive filler selected from those that have a coefficient of thermal conductivity that is greater than 5 W/m° K, greater than 10 W/m° K, or greater than 15 W/m° K.
49. Any one preceding embodiment, which additionally comprises a thermally conductive filler selected from alumina, alumina trihydrate or aluminum trihydroxide (ATH), silicon carbide, boron nitride, diamond, and graphite, and mixtures thereof. Particularly preferred are aluminium trihydroxide (ATH), and aluminium oxide, with ATH being the most preferred.
50. Any one preceding embodiment, which additionally comprises a thermally conductive filler selected from a mixture of ATH and alumina, in particular with a wt:wt ratio of ATH:alumina of 8-15.
51. Any one preceding embodiment, which additionally comprises a thermally conductive filler having a broad particle size distribution characterized by a ratio of D90/D50 of at or about 3 or more.
52. Any one preceding embodiment, which additionally comprises a thermally conductive filler which is ATH or aluminium oxide having a broad particle size distribution characterized by a ratio of D90/D50 of at or about 3 or more, most preferably ATH.
53. Any one preceding embodiment, which additionally comprises a thermally conductive filler selected from thermally conductive fillers having a bimodal particle size distribution.
54. Any one preceding embodiment, which additionally comprises a thermally conductive filler wherein the ratio D90/D50 of the thermally-conductive filler is at or about 3 or more, more preferably at or about 5 or more, more particularly preferably at or about 9 or more.
55. Any one preceding embodiment, which additionally comprises a thermally conductive filler selected from aluminium oxide and ATH having a bimodal distribution, and mixtures of these, particularly ATH.
56. Any one preceding embodiment, which additionally comprises a thermally conductive filler which is ATH having D90/D50 at or about 3 or more, more preferably at or about 5 or more, particularly preferably at or about 9 or more.
57. Any one preceding embodiment, which additionally comprises a thermally conductive filler which is bimodally distributed aluminium trihydroxide (ATH), having the following particle size distribution (by laser diffraction in deionized water containing a dispersion aid, such as Na₄P₂O₇×10 H₂O, preferably at 1 g/l):
   D₁₀ (micron) 0.5
   D₅₀ (micron) 8
   D₉₀ (micron) 80.
58. Any one preceding embodiment, which additionally comprises a thermally conductive filler which is present in the final adhesive at a concentration of 10-55 wt %, more preferably 15-45 wt %, more particularly preferably 20-42 wt %, based on the total weight of the adhesive.
59. Any one preceding embodiment, which additionally comprises a thermally conductive filler which is aluminium trihydroxide (ATH), used at a concentration of 10-55 wt %, more preferably 15-45 wt %, more particularly preferably 20-42 wt %, based on the total weight of the adhesive.
60. Any one preceding embodiment, which additionally comprises a thermally conductive filler which is aluminium trihydroxide (ATH), having the following particle size distribution (by laser diffraction in deionized water containing a dispersion aid, such as Na₄P₂O₇×10 H₂O, preferably at 1 g/l):
   D₁₀ (micron) 0.5
   D₅₀ (micron) 8
   D₉₀ (micron) 80
   used at a concentration of 10-55 wt %, more preferably 15-45 wt %, more particularly preferably 20-42 wt %, based on the total weight of the adhesive.
61. Any one preceding embodiment, wherein the adhesive composition additionally comprises one or more tougheners.
62. Any one preceding embodiment, wherein the adhesive composition additionally comprises one or more tougheners selected from polyurethane-based tougheners, rubber-based tougheners, core-shell rubber tougheners.
63. Any one preceding embodiment, wherein the at least one toughener is selected from those molecules bearing terminal functional groups that can react with the epoxy matrix during polymerization.
64. Any one preceding embodiment, wherein the at least one toughener is selected from polyurethane-based tougheners in which the terminal NCO groups are uncapped or capped (for example, with a phenol or polyphenol), polybutadiene-based tougheners terminated with amine or diol functionality.
65. Any one preceding embodiment, wherein the at least one toughener is selected from polyurethane tougheners, in particular those in which the terminal NCO groups are capped with phenol groups, in particular cardanol.
66. Any one preceding embodiment, wherein the at least one toughener is prepared by reacting a polybutadiene diol, a polyetherdiol and a diisocyanate, such that the resulting molecule bears terminal NCO groups.
67. Any one preceding embodiment, wherein the at least one toughener is prepared by reacting a polybutadiene diol, a polyetherdiol and a diisocyanate, such that the resulting molecule bears terminal NCO groups, followed by end-capping with a phenol or polyphenol.
68. Any one preceding embodiment, wherein the at least one toughener is prepared by reacting a polybutadiene diol, a polyetherdiol and a diisocyanate, such that the resulting molecule bears terminal NCO groups, followed by end-capping with cardanol.
69. Any one preceding embodiment, wherein the at least one toughener is used at 10-25 wt %, more preferably 12-18 wt %, based on the total weight of the adhesive.
70. Any one preceding embodiment, wherein the toughener is selected from polyurethane-based tougheners, rubber-based tougheners, and core-shell rubber tougheners, used at 3-25 wt %, more preferably 12-18 wt %, based on the total weight of the adhesive.
71. Any one preceding embodiment, wherein the at least one toughener is selected from those molecules bearing terminal functional groups that can react with the epoxy matrix during polymerization, used at 3-25 wt %, more preferably 12-18 wt %, based on the total weight of the adhesive.
72. Any one preceding embodiment, wherein the at least one toughener polyurethane-based tougheners in which the terminal NCO groups are uncapped or capped (for example, with a phenol or polyphenol), polybutadiene-based tougheners terminated with amine or diol functionality, used at 3-25 wt %, more preferably 12-18 wt %, based on the total weight of the adhesive.
73. Any one preceding embodiment, wherein the at least one toughener is selected from polyurethane tougheners, in which the terminal NCO groups are capped with phenol groups, in particular cardanol, used at 3-25 wt %, more preferably 12-18 wt %, based on the total weight of the adhesive.
74. Any one preceding embodiment, wherein the at least one toughener is prepared by reacting a polybutadiene diol, a polyetherdiol and a diisocyanate, such that the resulting molecule bears terminal NCO groups, used at 3-25 wt %, more preferably 12-18 wt %, based on the total weight of the adhesive.
75. Any one preceding embodiment, wherein the at least one toughener is prepared by reacting a polybutadiene diol, a polyetherdiol and a diisocyanate, such that the resulting molecule bears terminal NCO groups, followed by end-capping with cardanol, used at 3-25 wt %, more preferably 12-18 wt %, based on the total weight of the adhesive.
76. Any one preceding embodiment, wherein the adhesive composition additionally comprises one or more silane adhesion promoters.
77. Any one preceding embodiment, wherein the adhesive composition additionally comprises one or more silane adhesion promoters of the general Formula I:

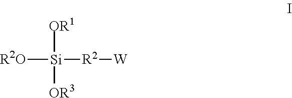

where R¹, R² and R³ are independently selected from C₁-C₄-alkyl, R² is a divalent C₂-C₆-alkylene radical, and W is glycidyl, amino or mercapto.
78. Embodiment 77, wherein in Formula I, W is glycidyl.
79. Embodiment 77 or 78, wherein in Formula I, R¹, R² and R³ are methyl and R² is propylene.
80. Embodiment 77, 78 or 79, wherein in Formula I, R¹, R² and R³ are methyl, R² is propylene, and W is glycidyl.
81. Any one preceding embodiment, wherein the adhesive composition comprises gamma-glycidylpropyltrimethoxysilane.
82. Any one preceding embodiment, wherein the adhesive composition additionally comprises a silane adhesion promoter present at 0.05-1 wt %, more preferably 0.1-0.75 wt %, more particularly preferably 0.2-0.4 wt %, based on the total weight of the adhesive composition.
83. Embodiment 82, wherein the silane adhesion promoter is of the general Formula I:

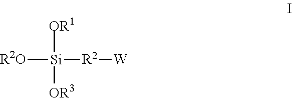

where R¹, R² and R³ are independently selected from C₁-C₄-alkyl, R² is a divalent C₂-C₆-alkylene radical, and W is glycidyl, amino or mercapto, used at 0.05-1 wt %, more preferably 0.1-0.75 wt %, more particularly preferably 0.2-0.4 wt %, based on the total weight of the adhesive composition.
84. Embodiment 82 or 83, wherein in Formula I, W is glycidyl, and the adhesion promoter is used at 0.05-1 wt %, more preferably 0.1-0.75 wt %, more particularly preferably 0.2-0.4 wt %, based on the total weight of the adhesive composition.
85. Embodiment 82, 83 or 84, wherein in Formula I, R¹, R² and R³ are methyl and R² is propylene, and the adhesion promoter is used at 0.05-1 wt %, more preferably 0.1-0.75 wt %, more particularly preferably 0.2-0.4 wt %, based on the total weight of the adhesive composition.
86. Any one of embodiments 82-85, wherein in Formula I, R¹, R² and R³ are methyl, R² is propylene, and W is glycidyl, and the adhesion promoter is used at 0.05-1 wt %, more preferably 0.1-0.75 wt %, more particularly preferably 0.2-0.4 wt %, based on the total weight of the adhesive composition.
87. Any one of embodiments 82-95, wherein the adhesive composition of the invention comprises gamma-glycidylpropyltrimethoxysilane, used at 0.05-1 wt %, more preferably 0.1-0.75 wt %, more particularly preferably 0.2-0.4 wt %, based on the total weight of the adhesive composition.
88. Any one preceding embodiment, wherein the adhesive composition additionally comprises one or more epoxy polymerization catalysts.
89. Any one preceding embodiment, wherein the adhesive composition additionally comprises one or more epoxy polymerization catalysts selected from a Lewis base and a Lewis acid.
90. Any one preceding embodiment, wherein the adhesive composition additionally comprises one or more epoxy polymerization catalysts selected from tertiary amines and imidazoles.
91. Any one preceding embodiment, wherein the adhesive composition additionally comprises one or more epoxy polymerization catalysts selected from 2,4,6-Tris(dimethylaminomethyl)phenol, tetramethylguanidine, heptamethylisobiguanide, N,N-dimethylbenzylamine.
92. Any one preceding embodiment, wherein the adhesive composition additionally comprises one or more epoxy polymerization catalysts which is 2,4,6-Tris(dimethylaminomethyl)phenol, in particular 2,4,6-Tris(dimethylaminomethyl)phenol on a novolac support.
93. Any one preceding embodiment, wherein the adhesive composition additionally comprises one or more epoxy polymerization catalysts used at 0.25-1.2 wt %, more preferably 0.5-1 wt %, based on the total weight of the adhesive composition.
94. Any one preceding embodiment, wherein the adhesive composition additionally comprises one or more epoxy polymerization catalysts which is a Lewis base, used at 0.25-1.2 wt %, more preferably 0.5-1 wt %, based on the total weight of the adhesive composition.
95. Any one preceding embodiment, wherein the adhesive composition additionally comprises one or more epoxy polymerization catalysts selected from tertiary amines and imidazoles, used at 0.25-1.2 wt %, more preferably 0.5-1 wt %, based on the total weight of the adhesive composition.
96. Any one preceding embodiment, wherein the adhesive composition additionally comprises one or more epoxy polymerization catalysts which is a tertiary amine, used at 0.25-1.2 wt %, more preferably 0.5-1 wt %, based on the total weight of the adhesive composition.
97. Any one preceding embodiment, wherein the adhesive composition additionally comprises one or more epoxy polymerization catalysts selected from 2,4,6-Tris(dimethylaminomethyl)phenol, tetramethylguanidine, heptamethylisobiguanide, N,N-dimethylbenzylamine used at 0.25-1.2 wt %, more preferably 0.5-1 wt %, based on the total weight of the adhesive composition.
98. Any one preceding embodiment, wherein the adhesive composition additionally comprises one or more epoxy polymerization catalysts which is 2,4,6-Tris(dimethylaminomethyl)phenol, in particular 2,4,6-Tris(dimethylaminomethyl)phenol on a novolac support, used at 0.25-1.2 wt %, more preferably 0.5-1 wt %, based on the total weight of the adhesive composition.
99. Any one preceding embodiment, wherein the one or more thermoplastic polymers has an average particle size of less than 100 μm.
100. Any one preceding embodiment, wherein the one or more thermoplastic polymers has an average particle size of greater than 5 μm.
101. Any one preceding embodiment, wherein the one or more thermoplastic polymers has an average particle size of 5-100 μm.
102. Any one preceding embodiment, wherein the at least one thermoplastic polymer is selected from those having melting temperatures between 140-200° C., more preferably 150-190° C.
103. Any one preceding embodiment, wherein the one or more thermoplastic polymers are selected from polyamides, polyesters and copolyetheresters, preferably in powder form.
104. Any one preceding embodiment, wherein the adhesive composition additionally comprises one or more thermoplastic polymers which is a polyamide, in particular a long-chain polyamide.
105. Any one preceding embodiment, wherein the one or more thermoplastic polymers is selected from long-chain polyamides made from a diacid, a diamine or a lactam or amino-carboxylic acid having 6-12 carbon atoms, preferably in powder form.
106. Any one preceding embodiment, wherein the one or more thermoplastic polymers is selected from PA66, PA6, PA11, PA12, PA410, PA610, PA1010, PA612, PA1212, preferably in powder form.
107. Any one preceding embodiment, wherein the one or more thermoplastic polymers is a polyamide selected from PA12, PA11, PA610, PA1010, PA612, PA1212, and mixtures of these, preferably in powder form, with PA12 being particularly preferred, preferably in powder form.
108. Any one preceding embodiment, wherein the one or more thermoplastic polymers is a copolyetherester, preferably in powder form, in particular a copolyetherester comprising PBT hard segments and PTMEG soft segments, preferably in powder form.
109. Any one preceding embodiment, wherein the one or more thermoplastic polymers is a polyester, preferably in powder form, in particular PBT, preferably in powder form.
110. Any one preceding embodiment, wherein the one or more thermoplastic polymers is used at 5-30 wt %, more preferably 7-22 wt %, particular preferably 8-15 wt %, based on the total weight of the adhesive composition.
111. Any one preceding embodiment, wherein the one or more thermoplastic polymers is in the form of powder, in a particular a powder having average particle size of less than 60 μm, and is used at 5-30 wt %, more preferably 7-22 wt %, particular preferably 8-15 wt %, based on the total weight of the adhesive composition.
112. Any one preceding embodiment, wherein the one or more thermoplastic polymers is selected from polyamides, polyesters and copolyetheresters, preferably in powder form, used at 5-30 wt %, more preferably 7-22 wt %, particular preferably 8-15 wt %, based on the total weight of the adhesive composition.
113. Any one preceding embodiment, wherein the one or more thermoplastic polymers is a polyamide, in particular a polyamide made from a diacid, a diamine or a lactam or amino-carboxylic acid having 6-12 carbon atoms, preferably in powder form, used at 5-30 wt %, more preferably 7-22 wt %, particular preferably 8-15 wt %, based on the total weight of the adhesive composition.
114. Any one preceding embodiment, wherein the one or more thermoplastic polymers is selected from PA66, PA6, PA11, PA12, PA410, PA610, PA1010, PA612, PA1212, preferably in powder form, used at 5-30 wt %, more preferably 7-22 wt %, particular preferably 8-15 wt %, based on the total weight of the adhesive composition.
115. Any one preceding embodiment, wherein the one or more thermoplastic polymers is selected from PA12, PA11, PA610, PA1010, PA612, PA1212, and mixtures of these, preferably in powder form, used at 5-30 wt %, more preferably 7-22 wt %, particular preferably 8-15 wt %, based on the total weight of the adhesive composition.
116. Any one preceding embodiment, wherein the one or more thermoplastic polymers is selected from PA12's, preferably in powder form, used at 5-30 wt %, more preferably 7-22 wt %, particular preferably 8-15 wt %, based on the total weight of the adhesive composition.
117. Any one preceding embodiment, wherein the one or more thermoplastic polymers is a copolyetherester, preferably in powder form, used at 5-30 wt %, more preferably 7-22 wt %, particular preferably 8-15 wt %, based on the total weight of the adhesive composition.
118. Any one preceding embodiment, wherein the one or more thermoplastic polymers is a copolyetherester selected from those comprising PBT hard segments and PTMEG soft segments, preferably in powder form, used at 5-30 wt %, more preferably 7-22 wt %, particular preferably 8-15 wt %, based on the total weight of the adhesive composition.
119. Any one preceding embodiment, wherein the one or more thermoplastic polymers is a polyester, preferably in powder form, used at 5-30 wt %, more preferably 7-22 wt %, particular preferably 8-15 wt %, based on the total weight of the adhesive composition.
120. Any one preceding embodiment, wherein the one or more thermoplastic polymers is a PBT, preferably in powder form, used at 5-30 wt %, more preferably 7-22 wt %, particular preferably 8-15 wt %, based on the total weight of the adhesive composition.
121. Any one preceding embodiment, wherein the adhesive composition shows decreased 12 mm peak core temperatures as compared to adhesives not comprising thermally-conductive filler, and/or as compared to adhesives not comprising thermoplastic polymer, when measured using the method recited in the Examples.
122. Any one preceding embodiment, wherein the adhesive composition shows 12 mm peak core temperatures of 275° C. or less, more preferably 260° C. or less, when measured using the method recited in the Examples.
123. Any one preceding embodiment, wherein the adhesive composition shows a percent expansion of 130% or more.
124. Any one preceding embodiment, wherein the adhesive composition shows 12 mm peak core temperatures of 275° C. or less, more preferably 260° C. or less, when measured using the method recited in the Examples, and a percent expansion of 130% or more.

### EXAMPLES

Ingredients are listed in Table 1.

TABLE 1
Ingredients

| Trademark | | |
|---|---|---|
| or | | |
| abbreviation | Chemical name | Structure |
| DER 331 | Bisphenol A | A liquid reaction product of |
| | diglycidyl ether | epichlorohydrin and bisphenol A, |
| | | having an epoxide equivalent |
| | | weight of 182-192 g/eq (as |
| | | measured according to ASTM D- |
| | | 1652), an epoxide percentage of |
| | | 22.4-23.6 % (as measured |
| | | according to ASTM D-1652), an |
| | | epoxide group content of 5200- |
| | | 5500 mmol/kg (as measured |
| | | according to ASTM D-1652), a |
| | | viscosity at 25° C. of 11,000- |
| | | 14,000 mPas (as measured |
| | | according to ASTM D-445), a |
| | | functionality of 2 |
| Silane A187 | Gamma- | Gamma- |
| | Glycidoxypropyl- | Glycidoxypropyl- |
| | trimethoxysilane | trimethoxysilane |
| | | 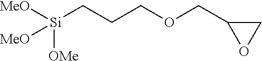 [SMILES: CO[Si](CCCOCC1CO1)(OC)OC] |
| Worflex 7525 | Polyurethane | Polyurethane |
| HC 100 | butadieneacrylo- | butadieneacrylonitrile copolymer |
| | nitrile copolymer | |
| DUALITE | Thermally | Thermally expandable |
| U005-190D | expandable | acrylonitrile copolymer |
| | acrylonitrile | microspheres containing |
| | copolymer | isopentane |
| | microspheres | |
| | containing | |
| | isopentane | |
| OMICURE | Dicyandiamide | Dicyandiamide |
| DDA-10 | | |
| EPCAT 50 | 2,4,6- | 2,4,6- |
| | Tris(dimethyl- | Tris(dimethylaminomethyl)phenol |
| | aminomethyl)phenol | on a novolac support |
| | on a novolac | |
| | support | |
| CAB-O-SIL | Fumed Silica | Fumed silica |
| Ultrabond | | |
| 5780 | | |
| HUBERCARB | Calcium | CaCO₃ |
| Q 325 | carbonate | |
| Apyral 20X | Aluminium | Al(OH)₃ |
| | hydroxide, | |
| | aluminium | |
| | trihydrate (ATH) | |
| Megasil SA | Spherical | Spherical Al₂O₃, D50 72 μm |
| 0700 | alumina, D₅₀ 72 | |
| | μm | |
| Megasil SA | Spherical | Spherical Al₂O₃, D50 5.7 μm |
| 0050 | alumina, D50 5.7 | |
| | μm | |
| Megasil | Mixture 7:3 wt:wt | Mixture 7:3 wt:wt of Megasil SA |
| mixture | of Megasil SA | 0700: Megasil SA 0050 |
| | 0700: Megasil SA | |
| | 0050 | |
| Graphene | Single and | Graphene |
| | multilayer | |
| | graphene powder | |
| Araldite DW | Red pigment | 2,2′-[(1-methylethylidene)bis(4,1- |
| 0133 Rot | | phenyleneoxymethylene)]bisoxirane |
| | | 70-90 wt% |
| | | 3,3′-[(2-chloro-5-methyl-p- |
| | | phenylene)bis[imino(1-acetyl-2- |
| | | oxoethylene)azo]]bis[4-chloro-N- |
| | | (3-chloro-o-tolyl)benzamide] 1-10 |
| | | wt% |
| Hytrel 4056P | Copolyetherester | Copolyetherester with PBT hard |
| | with PBT hard | segments and PTMEG soft |
| | segments and | segments in powder form, with |
| | PTMEG soft | average particle diameter of |
| | segments in | <500 μm |
| | powder form, with | |
| | average particle | |
| | diameter of <500 | |
| | μm | |
| Orgasol 2001 | a spheroidal | a spheroidal powder of |
| | powder of | polyamide 12, with 10 μm as |
| | polyamide 12, | average diameter and a narrow |
| | with 10 μm as | particle size distribution |
| | average diameter | |
| | and a narrow | |
| | particle size | |
| | distribution | |
| Orgasol 2002 | a spheroidal | a spheroidal powder of |
| | powder of | polyamide 12, with 50 μm as |
| | polyamide 12, | average diameter and a narrow |
| | with 50 μm as | particle size distribution |
| | average diameter | |
| | and a narrow | |
| | particle size | |
| | distribution | |
| Ultradur | PBT powder | PBT powder |
| CELLCOM | Azodicarbonamide | Azodicarbonamide |
| Lite 2020 | Cardanol | Cardanol |
| Quicklime | Calcium Oxide | Calcium Oxide |
| XZ92579 | Bisphenyl A | A liquid reaction product of |
| | Diglycidyl Ether | epichlorohydrin and bisphenol A, |
| | Resin | having an epoxide percentage of |
| | | 17.2-−18.3 % (as measured |
| | | according to ASTM D-1652), an |
| | | epoxide group content of 3800- |
| | | 4250 mmol/kg (as measured |
| | | according to ASTM D-1652), a |
| | | viscosity at 25° C. of 600-1000 |
| | | cST (as measured according to |
| | | ASTM D-445) |

### Preparation of Adhesive

Using the quantities listed in Table 2, the Comparative Sample and Inventive Samples were prepared as follows:

Epoxy resins (Silquest A-187 and D.E.R. 331) were weighed directly into a 300 long SpeedMixer™ cup followed by the Worflex 7525. The cup was capped and mixed in a Flacktek DAC600 SpeedMixer™ at 2,300 rpm for one minute. The mixture was removed from the SpeedMixer™ and allowed to cool, then mixed again using the same program. Next, thermoplastic polymer powder, red pigment, fumed silica and aluminum trihydrate (if used) were weighed into the cup. The cup was capped, and the cap was secured with masking tape. The contents were mixed twice in the Flacktek DAC600 SpeedMixer™ at 2,300 rpm for one minute, allowing time for the composition to cool in between mixes and maintain a temperature<65° C. CAB-O-SIL TS720 was added, and the composition was mixed again using the aforementioned protocol. Finally, the epoxy polymerization catalyst (EPCAT 50), Dualite blowing agent and dicyandiamide were added. The cup was capped and taped. The composition was mixed three times using the aforementioned protocol. Between mixes, the sample was scraped down from the cup walls and mixed manually using a tongue depressor. The final blend was capped with a lid containing a small hole, then de-aired using a FlackTek SpeedMixer model DAC 600 VAC. To avoid bumping, the rotational speed was increased from 900 rpm to 1800 rpm.

The percent volume expansion and peak core temperatures achieved at 180° C. oven temperature at 15 mm adhesive layer thickness were determined for each adhesive, and the results are summarized in Table 2.

### Expansion

Percent expansion by volume was determine by hydrostatic weighing. For example, a small metal coupon was hung from a balance and weighed in air and in a beaker of water. Adhesive was applied to the coupon, and it was weighed again in air and in water. The adhesive was cured at 180° C. for 30 minutes, and the resulting coupon with expanded adhesive was hung from the bottom of the balance and reweighed in air and in water.

Individual coupon results are calculated using the equation:

$$\% expansion = ( ( C C - UC ) \div ( UC - P C ) ) \times 100 \%$$

Where:
CC=difference between weight of coupon cured product in air and water.
UC=difference between coupon uncured product in air and water.
PC=difference between coupon in air and water.

### Peak Core Temperatures

The core peak temperature reached by each adhesive composition during cure was monitored by placing a thermocouple into the centre of the adhesive layer which was sandwiched between two metal plates. The sandwich specimens were prepared by dispensing adhesive onto a metal panel covered with Teflon paper (to prevent adhesion). The dispensed adhesive was cut to a dimension of 100 mm×25.4 mm×15 mm or 100 mm×25.4 mm×12 mm. Metal spacers (15 mm or 12 mm in height) were placed at each end of the resulting adhesive rectangular prism, and the assembly was topped with a second Teflon-covered metal panel. The assembly was secured with four metal clips. A thermocouple was then inserted into the centre of the adhesive layer through a small hole (˜1 mm diameter) in the centre of the bottom plate. A second thermocouple was taped to the metal panel to monitor the temperature of the metal, and a third thermocouple was secured to the oven rack on which the sample was placed in order to monitor the oven temperature. The final sandwich specimen was placed into a pre-heated oven a 180° C. for 30 minutes, and the peak core temperature was recorded for each sample.

### Flexural Properties of Sandwich Specimens

To evaluate flexural stiffness and strength, sandwich composites were prepared using 6061-T6 Aluminum coupons (200 mm l×25.4 mm w×1.6 mm t) and a 12 mm adhesive layer. Sandwich specimens were cured at 180° C. for 30 minutes and tested in 3-point bend according to ASTM D7624 procedure A using a support span of 120 mm and a test speed of 5 mm/min

TABLE 2
Compositions and characteristics of Comparative
(CE) and Inventive Examples (IE)

| | Example # | | | | | |
|---|---|---|---|---|---|---|
| | CE1 | IE4 | IE5 | IE6 | IE7 | IE8 |
| | wt % | wt % | wt % | wt % | wt % | wt % |
| Ingredient | | | | | | |
| DER 331 (epoxy resin) | 47.8 | 25.6 | 25.6 | 25.6 | 25.6 | 47.7 |
| XZ92579 (epoxy resin) | — | 25.6 | 25.6 | 25.6 | 25.6 | — |
| Silane A187 (silane) | 0.3 | 0.3 | 0.3 | 0.3 | 0.3 | 0.3 |
| Worflex 7525 HC 100 | — | 16.5 | 16.5 | 16.5 | 16.5 | — |
| DUALITE U005-190D | 1.3 | 0.6 | 0.6 | 0.6 | 0.6 | 1.2 |
| Cellcom | — | 0.5 | 0.5 | 0.5 | 0.5 | — |
| OMICURE DDA-10 | 4.3 | 4.2 | 4.1 | 4.2 | 4.1 | 4.2 |
| EPCAT 50 | 0.7 | 0.7 | 0.7 | 0.7 | 0.7 | 0.7 |
| CAB-O-SIL Ultrabond | 3.9 | 4.5 | 4.5 | 4.5 | 4.5 | — |
| 5780 | | | | | | |
| HUBERCARB | 41.3 | 3.7 | 3.7 | 3.7 | 3.7 | — |
| Quicklime | — | 2.0 | 2.1 | 2.0 | 2.1 | — |
| Lite 2020 | — | 5.1 | 5.1 | 5.1 | 5.1 | — |
| Apyral 20X | — | — | — | — | — | 25.1 |
| Megasil mixture | — | — | — | — | — | — |
| Araldite DW 0133 Rot | 0.4 | 0.5 | 0.5 | 0.5 | 0.5 | 0.3 |
| Hytrel 4056P | — | 10.2 | — | — | — | — |
| (copolyetherester) | | | | | | |
| Orgasol 2001 (PA12) | — | — | 10.2 | — | — | 20.5 |
| Orgasol 2002 (PA12) | — | — | — | 10.2 | — | — |
| Ultradur (PBT) | — | — | — | — | 10.2 | — |
| Data | | | | | | |
| % expansion | 147.8 | 136.2 | 158.9 | 149.2 | 145.6 | 137.7 |
| 12 mm peak core | 302 | 241.2 | 227.9 | 236.5 | 251.4 | 231.5 |
| temperature (° C.) | | | | | | |
| Bulk flex modulus (MPa) | 1021.1 | 275.8 | 428.1 | 429.6 | 452.0 | 999.0 |
| Bulk flex strength (MPa) | 7.89 | 5.18 | 9.35 | 9.73 | 8.71 | 14.94 |
| Bulk toughness (J/m³) | 0.034 | 0.074 | 0.169 | 0.197 | 0.140 | 0.125 |

As shown in Table 2, Comparative Example 1, which is an expandable structural adhesive composition which does not contain thermoplastic powder reached a peak core temperature of 302° C. In contrast, when thermoplastic powder was added, a 51-75° C. reduction in the peak core temperature was achieved. When both thermoplastic and thermally-conductive filler (ATH) are used, as in IE8, a decrease in the peak core temperature of 71° C. is achieved.

1. An expandable adhesive composition comprising:
(A) at least one liquid epoxy resin;
(B) at least one blowing agent;
(C) at least one hardener;
(D) at least one semi-crystalline thermoplastic in particulate form.

2-3. (canceled)

4. An expandable adhesive composition comprising:
(A) at least one liquid epoxy resin;
(B) at least one blowing agent;
(C) at least one hardener;
(D) at least one semi-crystalline thermoplastic in particulate form;
(E) at least one thermally-conductive filler.

5-6. (canceled)

7. The adhesive composition of claim 1, wherein the at least one liquid epoxy resin comprises epoxy resins that are flowable at 25° C. having a viscosity at 25° C. of less than 1,500,000 mPas, when measured according to ASTM D-445.

8. The adhesive composition of claim 7, wherein the at least one epoxy resin comprises an epoxy resin having a viscosity at 25° C. of less than 50,000 mPa·s, when measured according to ASTM D-445.

9. The adhesive composition of claim 1, wherein the epoxy resin comprises an epoxy resin selected from those formed by reaction of epichlorohydrin with bisphenols selected from bisphenol A, bisphenol AP, bisphenol AF, bisphenol BP, bisphenol B, bisphenol C, bisphenol E, bisphenol F, bisphenol G, bisphenol M, bisphenol S, bisphenol P, bisphenol Z.

10. The adhesive composition of claim 9, wherein the epoxy resin comprises an epoxy resin selected from epoxy resins resulting from reaction of epichlorohydrin with bisphenol A.

11-20. (canceled)

21. The adhesive composition of claim 1, wherein the blowing agent is selected from expandable graphite, and hydrocarbon gases.

22. The adhesive composition of claim 1, wherein the blowing agent is selected from:
1. Isocyanates
2. Azo-compounds
3. Hydrazine derivatives
4. Semicarbazides and sulfonyl semicarbazides
5. N-nitroso compounds
6. Tetrazoles
7. Poly(hydrosiloxanes)
8. Salts of carbonic and polycarboxylic acids
9. Peroxides.

23. The adhesive composition of claim 1, wherein the blowing agent is a hydrocarbon gas encapsulated in poly(acrylonitriles) and/or acrylate copolymers.

24. The adhesive composition of claim 23, wherein the blowing agent is selected from a propane, butane or pentane, encapsulated in poly(acrylonitriles) and/or acrylate copolymers.

25. The adhesive composition of claim 1, wherein the blowing agent is used at 0.25-2.35 wt %, based on the total weight of the adhesive composition.

26-29. (canceled)

30. The adhesive composition of claim 1, wherein the hardener is a latent hardener capable of being activated on exposure to heat.

31. The adhesive composition of claim 30, wherein the hardener is selected from dicyandiamide, hydrazides and anhydride hardeners.

32. The adhesive composition of claim 31, wherein the hardener is dicyandiamide.

33. The adhesive composition of claim 1, wherein the hardener is selected from phthalic anhydride, tetrahydrophthalic anhydride, hexahydrophthalic anhydride, methyltetrahydrophthalic anhydride, methylhexahydrophthalic anhydride, methyl-5-norbornene-2,3-dicarboxylic anhydride, alkenylsuccinic anhydrides, and trimellitic anhydride

34. The adhesive composition of claim 1, wherein the hardener is selected from adipic dihydrazide, sebacic dihydrazide, dodecanedihydrazide, isophthalic dihydrazide, and salicyclic dihydrazide.

35. The adhesive composition of claim 1, wherein the adhesive composition consists of an epoxy component and a hardener component wherein the two components are mixed immediately prior to use, and wherein the hardener is selected from polyamines, substituted triazines, imidazoles, and polycarboxylic acids.

36. The adhesive composition of claim 35, wherein the hardener is selected from aliphatic polyamines, cycloaliphatic polyamines, aromatic polyamines, polyether-based polyamines, polyethylenimines.

37. The adhesive composition of claim 35, wherein the hardener is selected from diethylene triamine, triethylene tetramine (TETA), triethylenediamine, tetraethylene pentamine, dipropenediamine, diethylaminopropylamine, N-aminoethylpiperazine, menthanediamine, isophoronediamine.

38. The adhesive composition of claim 35, wherein the hardener is selected from those based on poly(propylene oxide) having the following structures:

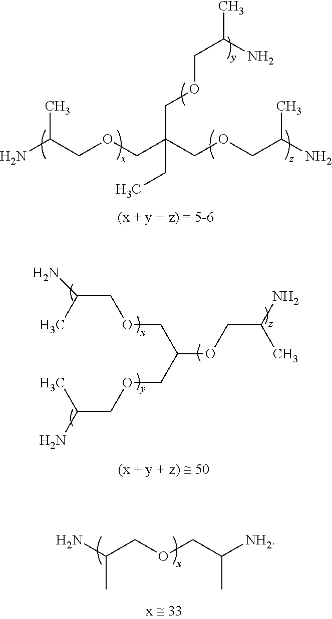

39-124. (canceled)
